(19) United States
(12) Patent Application Publication
(10) Pub. No.: US 2008/0168951 A1
(43) Pub. Date: Jul. 17, 2008

(54) SMALL ANIMAL RESTRAINING DEVICE WITH PHYSIOLOGIC SENSOR MOUNT

(75) Inventors: Eric W. Starr, Allison Park, PA (US); Patrick W. Truitt, Murrysville, PA (US); Bernard F. Hete, Kittanning, PA (US)

Correspondence Address: BLYNN L. SHIDELER;THE BLK LAW GROUP, 3500 BROKKTREE ROAD, SUITE 200, WEXFORD, PA, 15090, US

(73) Assignee: STARR LIFE SCIENCES CORP., Oakmont, PA (US)

(21) Appl. No.: 12/013,409

(22) Filed: Jan. 11, 2008

Related U.S. Application Data
(60) Provisional application No. 60/884,421, filed on Jan. 11, 2007.
(60) Provisional application No. 60/891,635, filed on Feb. 26, 2007.

(51) Int. Cl. A01K 1/06; A61D 3/00; A01K 29/00

(52) U.S. Cl. 119/751; 119/417

(57) ABSTRACT

A restraining tube for small animals (preferably animals with tails) is designed to facilitate physiologic measurements of the animal through an integrated or associated sensor mount. The physiologic sensors include those for the measurement of pulse oximetry and other measurements such as breath rate, heart rate, pulse distention and breath distention, temperature to name a few. A tail engaging sensor mount geometry is provided for a particular pulse oximeter into the back plate of the tube. The immobility of the animal is especially important given the fact that pulse oximetry measurements are extremely susceptible to even the smallest motion artifact.

### RELATED APPLICATIONS

This application claims the benefit of U.S. Provisional patent application Ser. No. 60/884,421 filed Jan. 11, 2007 entitled “Physiologic Sensor Mount Integral with Small Animal Restraining Device.”

This application claims the benefit of U.S. Provisional patent application Ser. No. 60/891,635 filed Feb. 26, 2007 entitled “Physiologic Sensor Mount Integral with Small Animal Restraining Device with Non-Traumatic Animal Loading Device and Stress Level Indicator.”

### BACKGROUND OF THE INVENTION

1. Field of the Invention

The present invention relates to physiologic sensor mounts for small animals, and more particularly to physiologic sensor mounts associated with small animal restraining devices with non-traumatic animal loading device and stress level indicator.

2. Background Information

Researchers who conduct experiments using rats and mice often require that their research animals be un-anesthetized during the experiment in order to avoid any effects from anesthesia that might skew the results. The primary difficulty associated with conducting tests on un-anesthetized subjects is their mobility. Some measurements, such as pulse oximetry, are very dependent on immobility of the subject.

One method commonly used for immobilizing subjects is a restraining device such as a restraint tube. Animal restraint tubes most often used in research are constructed generally of a clear plastic and have a slit that runs the entire length along the top of the tube. The tube is open on one end, and is closed on the other end, but the slit described above is joined on the closed end by a slit that runs to the center of the end cap.

To use the tube, one grabs the animal's tail, and pulls it through the slit from the open end of the tube, toward the closed end. Once the animal is pulled all of the way into the tube, a restricting ring or plate is slid into the open end of the tube to allow the user to push the animal into the tube and restrict its motion. With the securing of the restricting ring the animal is effectively immobilized and the research can proceed.

One drawback with conventional restraining tubes is that current restraint tubes are designed primarily for immobilization only. The restraining devices often restrict the measurements that can be taken due to limited access to the subject.

A further drawback is that loading of animals into restraining tubes can be traumatic for the animal with the associated physiologic changes to the animal from such stress which can delay the desired research. In other words, certain research will require the animal to calm down before the researcher can proceed.

Commercial examples of restraining tubes are known as “Broom Rodent Restrainers or Universal Rodent Restrainers. Examples in the patent literature include U.S. Pat. Nos. 3,625,185; 3,094,101; 6,446,579; and 5,927,234. These patents are incorporated herein by reference.

It is an object of the present invention to allow physiologic sensors to be easily utilized with un-anesthetized small animals and to provide for loading of animals within a restraining device with minimal trauma or stress on the animal and to have feedback regarding unacceptable stress levels in the animal subject.

### SUMMARY OF THE INVENTION

It is noted that, as used in this specification and the appended claims, the singular forms “a,” “an,” and “the” include plural referents unless expressly and unequivocally limited to one referent. For the purposes of this specification, unless otherwise indicated, all numbers expressing any parameters used in the specification and claims are to be understood as being modified in all instances by the term “about.” All numerical ranges herein include all numerical values and ranges of all numerical values within the recited numerical ranges.

The various embodiments and examples of the present invention as presented herein are understood to be illustrative of the present invention and not restrictive thereof and are non-limiting with respect to the scope of the invention.

As noted above, current restraint tubes are designed primarily for immobilization only. At least some of the above stated objects are achieved with the present invention that provides a restraining tube for small animals (preferably animals with tails) that is designed to facilitate physiologic measurements of the animal through an integrated or associated sensor mount. The physiologic sensors include those for the measurement of pulse oximetry and other measurements such as breath rate, heart rate, pulse distention and breath distention, temperature to name a few. The term pulse oximeter or pulse oximetry as used in this application preferably references a sensor configured to calculate all of these measurements. The present invention integrates a tail engaging sensor mount geometry for a particular pulse oximeter (a LED based transmittance system—however a reflective based system could also be used) into the back plate of the tube. The benefit of such a coupling is that immobility of the animal is especially important given the fact that pulse oximetry measurements are extremely susceptible to even the smallest motion artifact.

At least some of the above stated objects are achieved with the present invention that provides non traumatic animal loading device for loading a restraining tube for small animals (preferably animals with tails) that is designed to facilitate physiologic measurements of the animal through an integrated sensor mount.

At least some of the above stated objects are achieved with the present invention that provides a feedback signal indicative of high or unacceptable stress levels of an animal within a small animal restraining tube.

One non-limiting aspect of the present invention provides a small animal restraining tube with physiologic sensor mount comprising a tube configured to receive a small animal therein; a nosecone within the tube and coupled thereto and configured to abut the animal within the tube to confine the animal on one side of the tube; an endplate coupled to the tube and configured to confine a body portion of the animal on a side opposite the nosecone, whereby the body of the animal is confined within the tube between the nosecone and the endplate, the endplate including an opening there through configured to receive a tail of the animal when the animal is confined within the tube; a physiologic sensor mount configured to be secured to the tail of the animal when the animal is confined within the tube, the physiologic sensor mount configured to receive at least one non-invasive physiologic sensor there in, and configured to be supported by the end plate; and an axial restraining member coupled to the endplate and configured to prevent axial movement of the physiologic sensor mount when the physiologic sensor mount is secured to the tail of the animal.

The small animal restraining tube may further including a tail lashing member secured to the endplate configured to allow the tail to be lashed to the tail lashing member at an axial position closer to the distal end of the tail than the location of the physiologic sensor mount. The axial restraining member may be a vertical surface extending from the tail lashing member and configured to abut the physiologic sensor mount and wherein the axial restraining member is coupled to the endplate through the tail lashing member. The tail lashing member may include a recess configured to selectively receive the physiologic sensor mount therein.

The physiologic sensor mount may be a tail clip for pulse oximetry sensors. The small animal restraining tube may further include a cable receiving member coupled to the end plate wherein the cable receiving member is configured to receive a cable extending from the physiologic sensors received within the physiologic sensor mount. The small animal restraining tube may further include an aperture reducing plate selectively coupled to the end plate to reduce the area of the tail receiving opening through the end plate.

The physiologic sensor mount may include one portion that is integral with the end plate whereby the axial restraining member includes the material forming the integral connection between the sensor mount and the endplate.

In one non-limiting aspect of the invention a small animal restraining tube assembly with pulse oximetry sensor mount comprises a tube configured to receive a small animal therein; a nosecone within the tube and coupled thereto and configured to abut the animal within the tube to confine the animal on one side of the tube; an endplate coupled to the tube and configured to confine a body portion of the animal on a side opposite the nosecone, whereby the body of the animal is confined within the tube between the nosecone and the endplate, the endplate including an opening there through configured to receive a tail of the animal when the animal is confined within the tube; and a physiologic sensor mount configured to be secured to the animal when the animal is confined within the tube, the physiologic sensor mount configured to receive at least one non-invasive pulse oximetry sensor there in, and configured to be supported by the assembly.

In one non-limiting aspect of the invention a small animal restraining tube with physiologic sensor mount comprises a tube configured to receive a small animal therein; a nosecone within the tube and coupled thereto and configured to abut the animal within the tube to confine the animal on one side of the tube; an endplate coupled to the tube and configured to confine a body portion of the animal on a side opposite the nosecone, whereby the body of the animal is confined within the tube between the nosecone and the endplate, the endplate including an opening there through configured to receive a tail of the animal when the animal is confined within the tube; and a physiologic sensor mount configured to be secured to the animal when the animal is confined within the tube; and a temperature indicating mechanism coupled to one of the tube, the end plate or the nosecone.

One non-limiting aspect of the present invention provides a method of confirming tail blood flow in a small animal comprising the steps of attaching a pulse oximeter to the tail of the animal and utilizing error signals from the pulse oximeter as indication of a lack of blood flow through the tail of the animal. The method of the present invention may further include the step of utilizing the indication of lack of blood flow in the tail of the animal as an indication of at least one of the stress level and temperature of the animal.

One non-limiting aspect of the invention provides a small animal restraining tube comprising a tube configured to receive a small animal therein; a nosecone within the tube and coupled thereto and configured to abut the animal within the tube to confine the animal on one side of the tube; an endplate coupled to the tube and configured to confine a body portion of the animal on a side opposite the nosecone, whereby the body of the animal is confined within the tube between the nosecone and the endplate, the endplate including an opening there through configured to receive a tail of the animal when the animal is confined within the tube; and a tubular loader mechanism selectively coupled to the tube, wherein the loader mechanism is configured to selectively receive the animal therein and configured to transfer the animal to the retraining tube.

One non-limiting aspect of the present invention provides A small animal restraining tube comprising a tube configured to receive a small animal therein; a nosecone within the tube and coupled thereto and configured to abut the animal within the tube to confine the animal on one side of the tube, wherein the nosecone is axially moveable within the tube and selectively secured thereto, wherein the nosecone includes a handle non-rotationally fixed to the nosecone for advancing the nosecone axially along the tube; and an endplate coupled to the tube and configured to confine a body portion of the animal on a side opposite the nosecone, whereby the body of the animal is confined within the tube between the nosecone and the endplate, the endplate including an opening there through configured to receive a tail of the animal when the animal is confined within the tube.

These and other advantages of the present invention will be clarified in the brief description of the preferred embodiment taken together with the drawings in which like reference numerals represent like elements throughout.

### BRIEF DESCRIPTION OF THE FIGURES

FIG. 1 is a perspective view of a small animal restraining tube with physiologic pulse oximetry sensor mount and non-traumatic loader in accordance with one aspect of the present invention;

FIG. 2 is a is a perspective view of the small animal restraining tube with physiologic pulse oximetry sensor mount and non-traumatic loader of FIG. 1;

FIG. 3 is a is a perspective view of the non-traumatic loader of FIG. 1;

FIGS. 4-6 are perspective views of alternative end plates for the small animal restraining tube of FIG. 1;

FIG. 7 is a sectional schematic view of a non-traumatic loader and movable nosecone in accordance with one aspect of the present invention;

FIG. 8 is an end view of the non-traumatic loader and movable nosecone of FIG. 7;

FIG. 9 is an elevation side view a small animal restraining tube with physiologic pulse oximetry sensor mount and non-traumatic loader in accordance with one aspect of the present invention;

FIG. 10 is an end view of an end plate for use with the small animal restraining tube with physiologic pulse oximetry sensor mount and non-traumatic loader of FIG. 9;

FIG. 11 is an elevational side view of the end plate of FIG. 10;

FIG. 12 is an end view of a aperture reducing plate for use with the end plate of FIG. 10;

FIG. 13 is a perspective view of a small animal restraining tube with integral physiologic pulse oximetry sensor mount in accordance with one aspect of the present invention;

FIG. 14 is a perspective view of the end plate and integral sensor mount for use with the a small animal restraining tube with integral physiologic pulse oximetry sensor mount of FIG. 13;

FIG. 15 is a perspective view of the end plate and integral sensor mount of FIG. 14 with an pulse oximetry sensor;

FIG. 16 perspective view of the slide aperture reducing plate and integral sensor mount for use with the a small animal restraining tube with integral physiologic pulse oximetry sensor mount of FIG. 13;

FIG. 17 is a perspective view of the small animal restraining tube with integral physiologic pulse oximetry sensor mount of FIG. 13;

FIG. 18 is a perspective view of a hinged small animal restraining tube in accordance with one aspect of the present invention; and

FIG. 19 is a view of a sensor clip with pulse oximetry sensors and associated display for use with the small animal retraining tubes of the present invention.

### DESCRIPTION OF THE PREFERRED EMBODIMENTS OF THE INVENTION

The detailed advantages of the present invention will be described further below under separate headings. A summary overview of the invention in connection with the attached figures may be helpful.

The invention provides a small animal restraining tube 100 with physiologic sensor mount 214 (which may include a tail clip 400) includes a tube 100 configured to receive a small animal therein. The tube 100 may be take any number of forms such as circular in cross section (interior and exterior), rectangular, oval, a truncated side, or any desired shape. Many suitable materials can be used, but it is advantageous if transparent materials are used to allow for viewing of the animals. Molded acrylics and other polymers have proven cost effective and provide for MRI compatibility.

A nosecone 330 is within the tube 100 and selectively coupled thereto and configured to abut the animal within the tube 100 to confine the animal on one side of the tube 100. The nosecone can be formed out of similarly suitable materials as the tube 100.

An endplate 200 is coupled to the tube 100 and configured to confine a body portion of the animal on a side opposite the nosecone 330, whereby the body of the animal is confined within the tube 100 between the nosecone 330 and the endplate 200. The endplate 200 includes an opening 212 there through configured to receive a tail of the animal when the animal is confined within the tube 100.

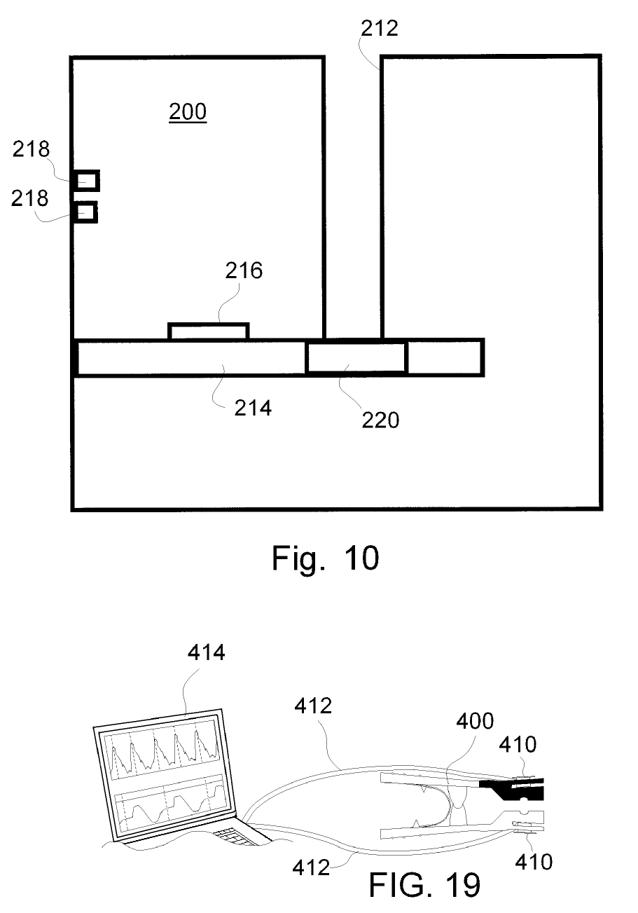

A physiologic sensor mount 214 may be provided and may include a tail clip 400. The mount 214 is configured to be secured to the tail of the animal when the animal is confined within the tube 100. The physiologic sensor mount 214 is configured to receive at least one non-invasive physiologic sensor 410 there in, and configured to be supported by the end plate 200. An axial restraining member 216 may be coupled to the endplate 200 and is configured to prevent axial movement of the physiologic sensor mount 214 when the physiologic sensor mount 214 is secured to the tail of the animal. The axial restraining member 216 may be a vertical surface extending from a tail lashing member 220 as shown in FIG. 10 and configured to abut the physiologic sensor mount 214 portion formed by clip 400. The axial restraining member 216 may be coupled to the endplate 200 through the tail lashing member 222. The tube 100 may include anti rotation members such as legs or a flattened lower portion of the tube 100 to prevent the tube 100 from rotating in use.

The tail lashing member 220, if provided, is secured to the endplate 220 and is configured to allow the tail to be lashed to the tail lashing member 220, generally at an axial position closer to the distal end of the tail than the location of the physiologic sensor mount 214. The lashing of the tail of the animal to the member 220 is through tape or tie down members and is used to minimize movement of the tail which can effect sensor measurements. The tail lashing member 220 may includes a recess configured to selectively receive the physiologic sensor mount 214 portion formed by clip 400 therein, and the tail clip 400 may form a physiologic sensor mount for pulse oximetry sensors 410.

The tube 100 may further include an access opening 124 at a lower position thereof adjacent the endplate 124 that is configured to allow for outflow of animal waste products of animals confined within the tube 100. The tube 100 may further including a cable receiving member 218 coupled to the end plate 200 wherein the cable receiving member 218 is configured to receive a cable 412 extending from the physiologic sensors 410 received within the physiologic sensor mount 214.

The nosecone 330 is axially moveable within the tube 100 and selectively secured thereto, wherein the nosecone 330 includes a handle 334 non-rotationally fixed to the nosecone 330 for advancing the nosecone 330 axially along the tube 100. The nosecone 330 includes a threaded shaft 332 non-rotationally secured thereto with the handle 334 non-rotationally secured to the shaft and a locking member 36 threaded to the shaft 332.

As discussed below, the end plate 200 and the physiologic sensor mount 214 may be rotational relative to the tube 100 to allow for pivoting of the sensors 410 to obtain a better signal.

The tube 100 may include an aperture reducing plate 222 selectively coupled to the end plate 200 through a slot in the tube 100 adjacent the plate 200 to reduce the area of the tail receiving opening 212 through the end plate 200.

The physiologic sensor mount 214 may include one portion that is integral with the end plate 200 whereby the axial restraining member includes the material forming the integral connection between the sensor mount 214 and the endplate 200.

The small animal restraining tube 100 may further include a temperature indicating mechanism or strip 130 coupled to the tube 100. The temperature indicating mechanism may be a temperature strip adhesively secured to the tube and allows the ambient temperature to be easily ascertained.

The present invention further provides a method of confirming tail blood flow in a small animal comprising the steps of attaching a pulse oximeter (sensor 410) to the tail of the animal and utilizing error signals from the pulse oximeter as indication of a lack of blood flow through the tail of the animal. The method of the invention may further including the step of utilizing the indication of lack of blood flow in the tail of the animal as an indication of at least one of the stress level and temperature of the animal.

The small animal restraining tube 100 according to the invention may further include a tubular loader mechanism 300 selectively coupled to the tube 100, wherein the loader mechanism 300 is configured to selectively receive the animal therein and configured to transfer the animal to the retraining tube 100. The tubular loader mechanism 300 may be configured to selectively receive the nosecone 330 therein and the nosecone 330 may be configured to transfer the animal from the loader mechanism 300 to the tube 100.

The particular features of the present invention will be further clarified in the following headings.

Geometries for Holding the Pulse Oximeter Sensor

The basic design of the retraining device or restraining tube 100 according to the present invention includes the use of mechanisms, called mounts 214 to hold a pulse oximeter sensor pair 410 for transmittance pulse oximetry, or a single sensor head for reflectance pulse oximetry. In the case of the pair of sensors 410 (as shown in some of the figures), one contains the red and infrared LED lights, while the other includes a photodiode to receive the transmitted light. In a reflectance arrangement, the LEDs and photodiode are contained in one sensor head.

In the transmittance pulse oximetry design that we have developed, the tube 100 accommodates a standard pair of transmittance sensor pads 410. FIG. 19 shows these pads or sensors 410 mounted in a tail clip 400 and are used with, and coupled to by cables 412, a pulse oximeter control box and computer 417, such as sold by Starr Life Sciences under the MouseOx™ brand name. The tail clip 400 is also available from Starr Life Sciences. The tail clip 400 is considered as at least part of the physiologic sensor mount 214 of the present invention in embodiments using the tail clip 400. With the tail clip 400 the physiologic sensor mount 214 may further comprise a recessed portion of the tail lashing member 220.

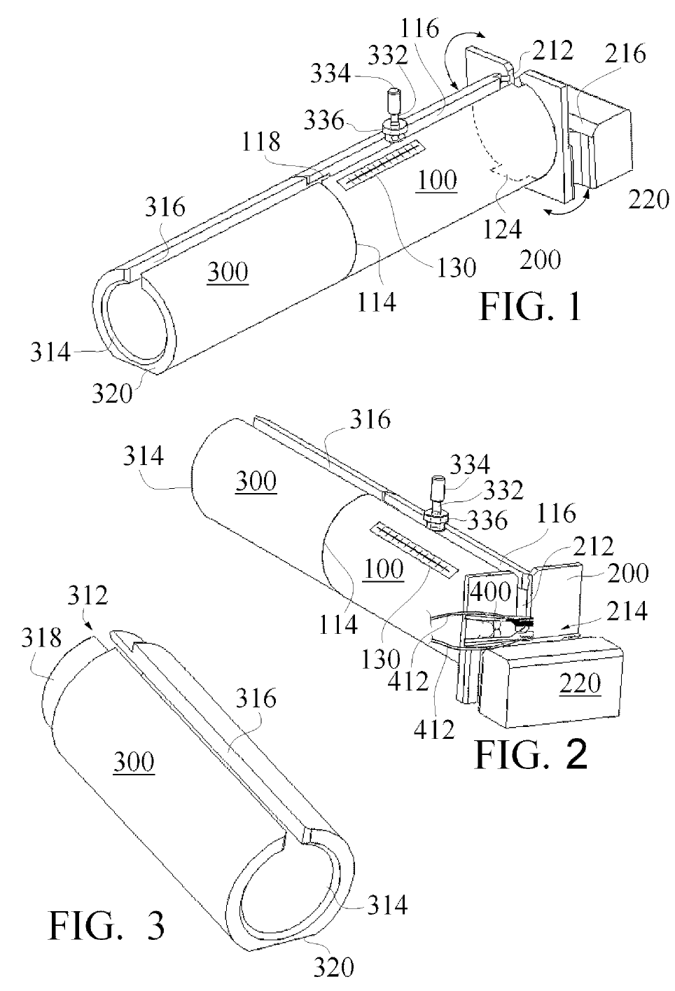

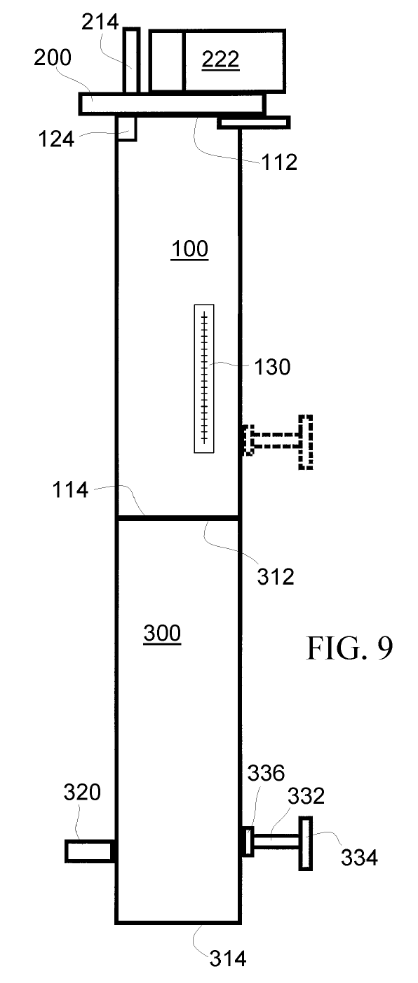

The sensor holding mechanisms, such as clips 400, of the restraint tube 100 are used simply as a mechanism for holding this particular sensor pair. It is possible to design a tube 100 with mounts 214 to accommodate a number of different types of sensors, both paired and single, as is the case with reflectance pulse oximetry. It is also possible to integrate either the LEDs or photodiode or both directly into the tube 100 and simply make an electrical connection to the control unit. As shown in the figures, the clips 400 can be used with the tube 100 embodiments of FIGS. 1-2, 4-6, 9-11 and 18.

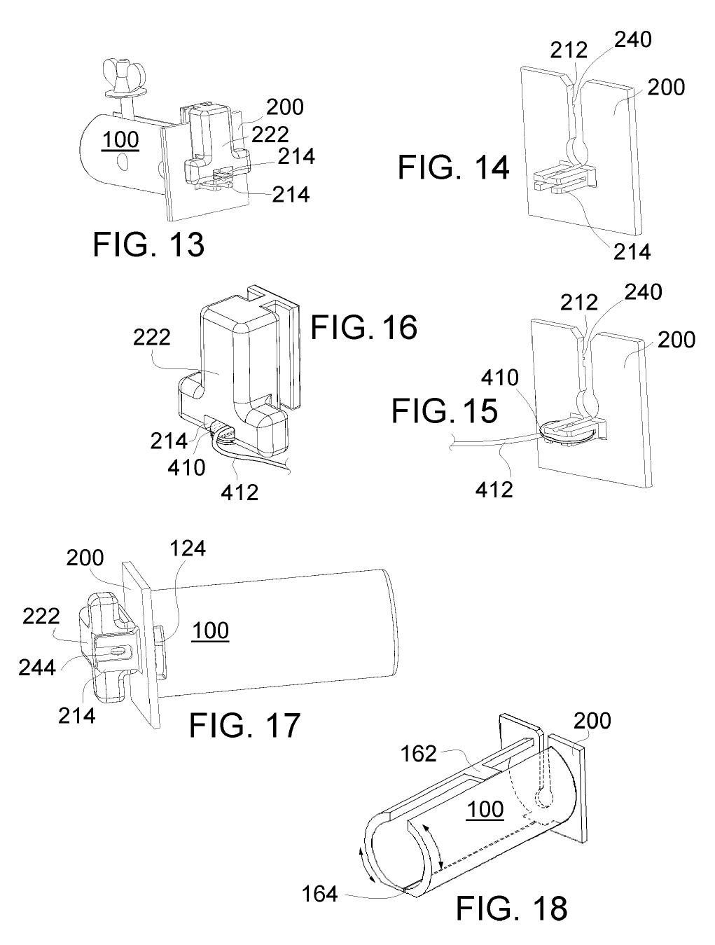

In another embodiment of the tube 100 design, the photodiode sensor pad 410 is slid into a holding mechanism or mount 214 located on the restraint tube end cap or plate 200, just below the opening 212 from which the tail of the animal passes. This embodiment can be seen in FIGS. 13-17. The end cap or plate 200 has the opening 212 formed as a slot that extends vertically from the bottom tail hole as described above. This slot portion of the opening 212 provides a guide for the LED sensor holder 222, also called an aperture reducing plate 222. This holder 222 fits in the slot of opening 212 and can slide up and down, and may be locked into place with a set screw or other type of holding mechanism once it is slid into position on top of the tail. The securement of this holding member or plate 222 will prevent the “thrashing” of the tail from moving the sensor 410 held in the mount 214 of this plate 222. The holding of the tail will prevent obfuscating the results. The slider or plate 222 contains a holding mechanism or mount 214 into which is slid one of the LED sensor pads 410 as shown in FIG. 16.

During use, the animal's tail may be pulled along the tube 100 without this slider or plate 222 in place until the tail extends out of the opening 212 in the end plate 200. The tail may merely be guided as the nosecone 330 is used to non-traumatically guide the animal back into the desired position in tube 100, as well, as described below. The slider or plate 222 is then engaged into the tube end plate 200 and slid down until the sensor 410 contacts the tail of the animal. Slight pressure on the slider 222 will push the tail down on the lower photodiode 410, already resident in the tube end plate 200. With direct contact by both the LEDs and photodiode of sensors 410, pulse oximetry measurements can be made in an effective manner that will not encounter animal movement that could detrimentally affect the results.

Rotating Back-Plate to Allow Optimization of Signals

In one embodiment of the present invention the end plate 200 and slider or plate 222 rotate relative to the tube. A snap bead 240 fitting between the end cap or plate 200 and the tube 100 will allow for attachment and relative rotation there between. This modification allows for the optimization of the pulse oximeter signal without moving the animal inside the tube 100. The relative rotational position of the sensors 410 can be adjusted until the strongest relative signal is obtained

Hinged or Split Backplate for One-Handed, Quick Turnaround Use

In some types of experiments, a user pulls multiple animals into a tube 100, one after the other. In such a case, speed is significant. One difficulty associated with the slider mechanism formed by the moving nosecone 330 described above is that the user may have to pull the animal in, then grab the nosecone 330 and locate it in its position. Another concept that might make serial measurements easier is to have a back or end plate 200 that is either hinged or split, and has the both sensor heads 410 already located in place. For example, if the end plate 200 were split down the middle vertically and hinged at the base, and the mechanism or mounts 214 that holds the LED sensors 410 were already attached to either the moving or non-moving portion of the end cap 200, the moving portion could be quickly slid into position after the animal was located in the tube 100.

Tube/Backplate Quick Fit (Magnetic, Velcro, Press-Fit)

Another modification of the present invention is the provision of the back or end plate 200 that is detachable from the tube 100 and is held on by a rapid attachment mechanism, such as a magnetic ring on the plate 200 and ferrous ring on the tube 100, or vice versa. Hook and loop type fasteners (e.g. Velcro® brand) could be used. Further the simple press-fit connection 240 described would make the end cap or plate 200 detachable as well.

One benefit to a detachable end plate 200 is that instead of pulling the animal into the tube by the tail, the animal could be allowed to crawl into the tube 100 on its own, then have the end plate 200 placed on the tube 100. Food at the nose cone 330 or stopper could be provided to entice the animal in the restrained environment of the backless tube 100.

Delivery of Gas, Particulates, Aerosols and Volatiles Via Tubing Nose Cone

An important element of the restraint tube 100 is the sliding nose cone 330 that is inserted into the open end of the tube 100 after the animal has been pulled into it, or is in place as the animal crawls in with an attachable end plate discussed above, or is slid in from the loader 300 as discussed further below. The nose cone 330 is what prevents the animal from simply crawling back out of the end 114 of the tube 100 opposed from the end plate 200. The nose cone 330 design may have a hole in the center that is used to allow the animal to breathe fresh air.

In one embodiment of the present invention the nose cone 330 (which may or may not have a hole in the center) has a nipple or other projection with a pass-through hole for fitting of a hose that can be used to deliver any gas, particulates, aerosols, liquids and/or volatiles into the tube. These might be delivered for the purpose of testing and evaluating the physiologic response of the animal by measuring oxygen saturation, breath rate, heart rate, or any other parameter that could be measured using the tube. However, it is not necessary to make these measurements if for some reason the tube 100 were to be used simply as a delivery or collection device.

In another embodiment, the nose cone 330 may have more than one port for either delivery or sampling of gas from inside the tube 100. The nipple may even have a projection on the opposite side of the nose cone 100 (the side on which the animal resides) in order to allow gas sampling to be conducted at some distance inside the tube from the nose cone 330.

The tube 100 may, if desired, be completely sealed from the outside environment. In other words, in a non sealed environment, further holes may be located in the tube 100. These holes will provide access locations to the animal for other observations, measurements, and general animal access (e.g. to give the animal an injection). Of course, the slot 116 through which the animal's tail is pulled must be sealed if a sealed environment is desired. Further the egress opening 124 must be eliminated for a sealed environment in order to seal the tube 100, if desired. In an open environment no slot seal is needed. A slot seal may be done any number of ways, but one suggestion is a simple sealing sleeve that slides over the restraint tube 100 from the open end 114. This could also be done by a pair of elastic-type flaps engaging across the slot 116 but which will allow the passing of the tail and the locking stud 332 of the nose cone 330. A similar approach could be used to seal around the tail in the end cap or plate 222 for a completely sealed restraining device.

Pulmonary and Other Measurements from Restraint Tube

The restraint tube 100 could also be used to make pulmonary measurements on the animal. When the animal is placed in the tube 100, the tube 100 essentially acts like a body box, similar to those used to make various pulmonary and metabolic measurements on animals. For example, respiratory measurements could be made by either measuring flow into and out of the tube 100 if it is sealed, or by measuring the pressure differential between the inside of the tube 100 and the atmosphere. One could also make thermal measurements on the inside of the tube, and make such measurements on the exhaled gas.

Regarding metabolic measurements, both delivered and exhaled oxygen into and out of the tube 100 could be measured. Similarly, carbon dioxide measurements could also be made. From this, one could glean metabolic activity, or even make measurements of cardiac output.

Pulmonary Measurements in Conjunction with Delivery of Gas, Particulates, Aerosols and Volatiles

The measurements described above may be made while delivering different types of gases, particulates, aerosols, liquids or volatiles to the subject.

Fixed Stud on Restraining Plug for Ease of Use

Current commercial restraint tube designs include nose cones that often have a locking nut or screw that is attached to the nose cone, and that binds the nose cone against the tube via the slot that runs the length of the top of the tube. One of the drawbacks to current designs is that the screw or nut moves relative to the nose cone itself. In these designs, the user grabs the nut or screw to pull the nose cone into the tube after the animal has been located in the tube. The difficulty with this arrangement is that since the nose cone can rotate relative to the screw or nut, the nose cone can turn while pulling it into the tube, making alignment of the nose cone and tube lumen difficult.

We have devised a design in which a threaded stud 332 is solidly locked onto the nose cone 330. This allows the user to control the angular position of the nose cone 330 as it is brought into the end 114 of the tube 100, making the procedure much simpler. The stud is threaded, to allow a nut 336 of some sort to be tightened against the tube 100. The key is that the stud 332 does not move relative to the nose cone 330 so the stud 332, or attached handle 334 can be used as a grasping point. Further the stud 332 and associated handle 334 may extend well beyond the associated nut 336 to provide an easy grasping point for the user.

Tube Posterior Cleaning Access Hole

One of the difficulties associated with current restraint tube designs is that they are very difficult to clean, particularly on the end where the tail exits against the end cap. The animal often defecates against the end cap, and this is very difficult to clean out. We have developed a design that has a small access or egress hole 124 cut into the tube 100 against the end cap or plate 200. This allows much of the animal's waste products (i.e. urine and feces) to flow out of the tube 100 on its own and further allows material lodged against the end cap or plate 200 to be flushed out easily with water.

Hinged/Spring-Loaded Split Tube for Grasping Animals

Another difficulty associated with using restraint tubes is that the animals will often fight to keep themselves from being pulled into the tube. We have proposed a tube 100 shown in FIG. 18 that is split along its length and is either hinged 164, or is easy to grasp as 2 pieces with one hand. The animal can then be set on a surface and held by the tail with one hand while the tube 100, opened at the hinge 164, is brought down over the animal with the other hand. Once in place, the tube 100 can be closed over the animal to restrain it. A locking latch 162 at the upper end will hold the tube halves in the secured position around the animal. Separate locking positions in the latch 162 (in a releasable ratchet type arrangement) can allow for the single tube halves to be used with a variety of different sized animals, as the ratchet positions can vary from animal to animal.

V-Groove for Tail Motion Restraint

One of the difficulties associated with making oximetry measurements on the tail, in addition to limited blood flow, is that the tail is a very muscular appendage that is in nearly continuous motion in an un-anesthetized animal as is the case in a restraint tube. Because pulse oximetry is so highly subject to motion artifact, it is imperative that tail motion be restrained as much as possible. This can be done simply by clamping down on the tail, but such a response would reduce or eliminate blood flow into the tail. An approach that we have developed is to have the sensor holding mechanisms 214 on either the LED side, photodiode side, or both, have a groove, such as a “V”-groove, cut in the direction that the tail lies. The V-groove allows force to be applied and distributed along the length of the tail that contacts the groove. Because force is distributed, contact pressure concentrations do not occur, reducing the likelihood of pinching off blood flow to the tail. Additionally, because of the “V” shape, the contact force is applied as a vector perpendicular to the face of the V. This contact point provides force vectors in both the vertical and horizontal directions. Another benefit of a V-groove over a curved groove is that the functionality of the V-groove is not compromised by the tail diameter. Thus, a carefully designed groove dimension could accommodate a range of tail diameters that would correspond to the animal weights designated for a given tube size (manufacturers offer multiple tube sizes, each of which is designated for a range of animal weights).

Other embodiments of this type of system include different shapes other than a “V” that could provide the same functionality as described above. One such shape is a curved groove, either convex or concave. Another embodiment is a series of interlocking teeth with a curved or “V” shape that distributes the force on alternate teeth.

A separate concept for restraining the tail is to have a tail receiving recess 242 in the tail lashing member 220. This member serves to restrain the tail for better measurements with the sensors 410.

Trumpet/Rounded Tube Open End

When pulling a mouse or rat into a restraining tube, the animal often grabs the sides of the open end of the tube with its paws, and it can be difficult to pull the animal into the tube. Sometimes a tremendous amount of force is required to pull the animal into the tube. In some cases, the force is large enough such that it is possible to damage the tail. This activity additionally causes a certain amount of trauma to the animal, which increases its anxiety, a response that may deleteriously affect measurement accuracy.

In order to improve the ability to pull the animal into the restraint tube, we have shaped the end of the tube in one embodiment to make it more difficult for the animal to resist being pulled into the tube. This can be done using any number of conical shapes that prevent the animal from getting its paws to catch on the outside edge of the tube. The shape can be conical or like a trumpet horn. In any case, the goal is to make a smooth surface that is difficult for the animal to grip. Another approach is to simply round off the end of the tube wall or bevel or camphor the end to affect the same result.

Hand-Warmer Heater for Assisted Tail Perfusion

The two primary difficulties associated with making oximetry measurements on a tail are motion artifact and low blood flow. Regarding the latter issue, it is known that murine animals have the ability to shunt blood flow from their tails. We have found in various experiments that blood shunting can be a very common occurrence, and that body temperature seems to play a large role in tail perfusion. It is our experience that in a laboratory environment, it is very common for the body temperature of the animal to drop, and we have seen that reduced temperature can be correlated with perfusion, particularly of the appendage on which oximetry measurements are being made.

To promote perfusion by maintaining body temperature of the animal, we have recommended the use of external heating to keep the body temperature of the animal at normal values. There are a number of ways to heat the animal including heating pads, laying the animal on a block soaked in hot water, convective heaters, etc. One in which we are particularly interested because of its ease of use, low cost and lack of need of an external power source is an air or chemically activated thermal pads known otherwise as hand warmers or hot packs. These devices can provide a constant low level of heat to the animal for a number of hours. The pads can simply be placed under the tube, but a mechanism could be fashioned on the tube to actually allow insertion or attachment of a given pad design.

Adhesive Surface-Mount Temperature Measurement Device Inside Tube to Monitor Animal Temperature

In order to assess the optimal temperature at which to keep the animal, we have devised a method of using an adhesive-backed, surface-mount temperature strip 130 that would allow the user to see the temperature of the animal during the experimentation. This sensor can be placed on the inside or outside of the tube 100, and can be used as a permanent attribute of a given tube 100 design. It could also be used on a disposable basis.

In addition to making sure that the animal is properly warmed, it can also be used to verify that an animal is not overheated.

MRI-Compatible Tube

In one aspect of the present invention all of the parts of the tube 100 and associated element are made from materials that are MRI compatible. This is achieved by not using ferrous materials, or non-ferrous materials that affect MRI measurements.

Physiologic Tail Sensor Mounting Arrangement Using Clips

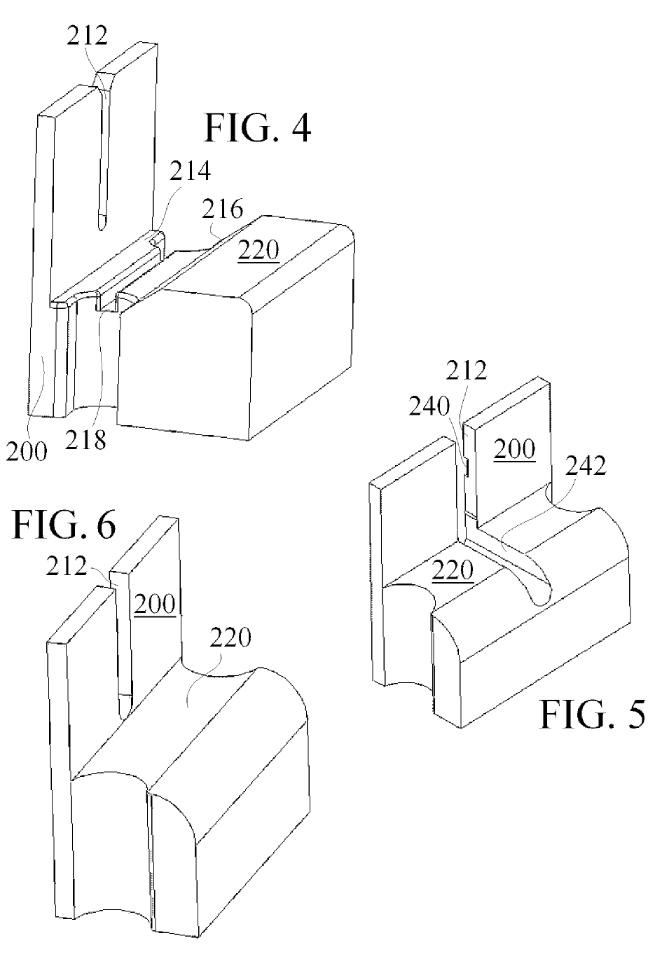

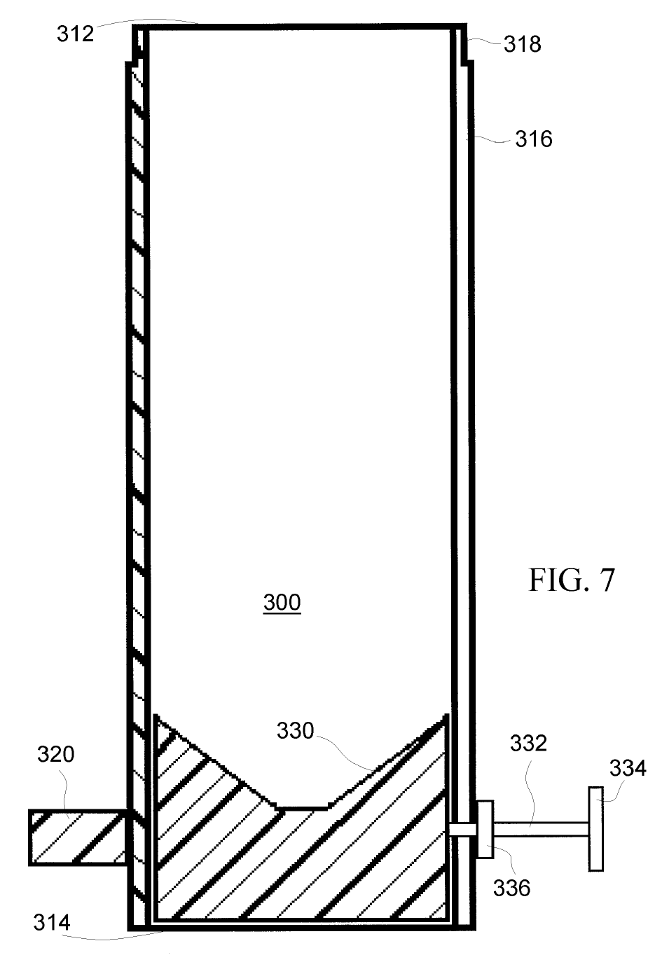

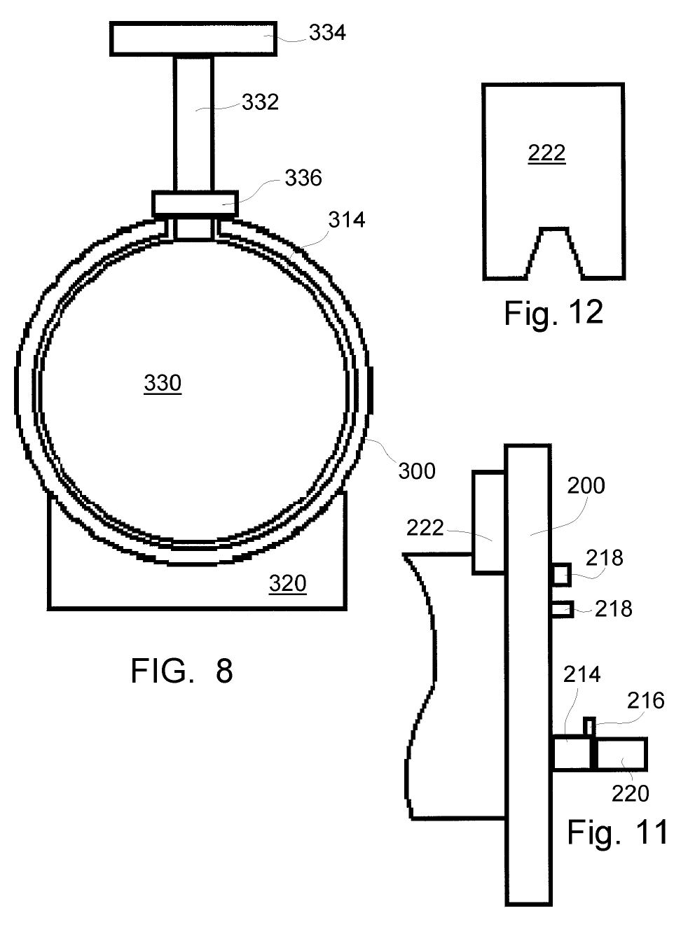

As described above a physiologic tail sensor mounting arrangement for the restraining tube 100 may use an end plate 200 with a tail receiving slot 212. The arrangement 200 may be configured to use conventional tail clip 400 mounted sensors 410 as shown in FIG. 19 that are supported on the sensor mounting shelf that forms the remaining part of the mount 214. A vertically extending axial stop 216 is provided, whereby a sensor clip receiving trough is formed by the stop 216, the shelf 214 and the end plate 200 (as shown in FIGS. 5 and 11). The cable 412 from the clip 400 mounted sensors 410 is received in cable mounts 218 (FIGS. 10-11) that form a strain relief for the cable 412 and associated sensors 410. The cable mounts 218 may be formed as cable receiving grooves as shown in FIG. 4. Extending from the shelf 214 is a tail lashing board 220 that allows for the researchers to lash down the tail conveniently if desired. The length of the board 220 can be varied and it may include lash receiving notches that would prevent axial movement of a lashing wire (e.g. a tie band or zip tie). An upper stop may be provided extending from the end plate 200 to further restrain the clip 400, but such may not be needed with the use of a tail restraining plate 222 that can be slid into position to minimize axial movement of the tail (and hence of the tail clipped sensor).

The bottom surface of the plate 22 is preferable beveled to force the rear of the subject toward the front of the tube for better positioning of the animal. A variety of tail mounted sensors could be used, but the tail mounted clip sensor from Starr Life Sciences with a tail locating mechanism is preferred.

Non-Traumatic Animal Loading Device

A non-traumatic animal loading device or tube 300 is a further aspect of the present invention and the loading device is formed as a tube 300 with two open ends 312, and 314 with a slot 316 extending the length of the tube 300. The tube 300 includes a tube coupling mechanism 318 at least at one end thereof, and may include a supporting leg 320 that also acts as an anti-rotation mechanism to maintain the tube 300 in a proper orientation. A flat bottom of tube 300 could also form an anti rotation mechanism. The nose cone 330 with threaded post 332, handle 334 and locking nut 336 is slidably received therein and may be selectively locked in position through tightening of nut 336 against the tube 300. As shown earlier the nut 336 can be formed as a large wing nut.

In operation, the device 300 can be placed in proximity to the animals to be loaded and the researcher can wait for a subject to crawl into a loader device 300. Mice and small rodents tend to like to crawl into and explore such tube shapes such that no prompting is required, however, food (e.g. peanut butter) could be added to the nose cone 330 as an enticement if needed. Once the animal subject is within the device 300 the researcher can snap the device 300 to a restraining tube 100 according to the invention through attachment 318 (with tube 100 having a similar coupling). This operation will not cause significant stress to the animal that are, presumably used to such handling. Once in this location, the researcher can slide the nose cone 330, via handle 334, along slot 316 into the tube 100. This will cause the animal to back up into position within the tube 100. This operation is far less traumatic on the animal than dragging them into the tube 100. With less stress or trauma being induced into the animal the animal will be in a more suitable condition for most research projects.

### Stress Level Indicator

Another object of the present invention is providing feedback to the researcher that can be indicative of a high or unacceptable stress level in the animal. The present physiologic sensor mounting device is useful for blood flow sensing devices, such as pulse oximetry sensors, on the tail of the animal as described above. When using such blood flow sensors on the tail the system can be configured to provide an additional stress level feedback to the researcher. It has been discovered that mice and rats can restrict the blood flow to their tails when under high stress situations (and also in extreme cold conditions). Consequently the blood flow based sensors, such as pulse oximeters, can not obtain a rectifiable signal when the animal is in such a stressed condition and stops (occasionally referenced as shunting) blood flow to the tail. When the sensor is in place on the animal and no signal is being received, the present invention supplies a notification to the researcher regarding the possible high stress condition of the animal. Therefore for those research projects requiring the subject to begin in a calm state the researcher will have some further verification when the subject is calm and when the subject is possibly in a high stress state. It is up to the researcher to handle what is done with this additional subject information, and it may be irrelevant for many studies.

Animal Calming Features

In addition to the loading device 300 of the invention, other aspects of the invention attempt to minimize the trauma or stress induced to the animal by the restraining device itself. The clean out orifice allows the interior of the tube to be maintained substantially free of animal waste that should be helpful for calming the animal, or not agitating the animal. Further, forming the loader or the restraining tube out of a calming darker color may be helpful. Where complete visibility is needed the restraining tube may be clear, and a covering blanket can be provided to encase the restraining tube allowing the animal to be covered to calm down in the darkened environment. The raising of the loading device and the restraining tube allows for easy introduction of heating elements that increases blood flow and is believed to assist in calming the animals. The legs prevent unwanted rotation of the tube and/or the feeder device that will also prevent undesired agitation of the animals.

Although the present invention has been described with particularity herein, the scope of the present invention is not limited to the specific embodiment disclosed. It will be apparent to those of ordinary skill in the art that various modifications may be made to the present invention without departing from the spirit and scope thereof.

What is claimed is:

1. A small animal restraining tube with physiologic sensor mount comprising:
A tube configured to receive a small animal therein;
A nosecone within the tube and coupled thereto and configured to abut the animal within the tube to confine the animal on one side of the tube;
An endplate coupled to the tube and configured to confine a body portion of the animal on a side opposite the nosecone, whereby the body of the animal is confined within the tube between the nosecone and the endplate, the endplate including an opening there through configured to receive a tail of the animal when the animal is confined within the tube;
A physiologic sensor mount configured to be secured to the tail of the animal when the animal is confined within the tube, the physiologic sensor mount configured to receive at least one non-invasive physiologic sensor there in, and configured to be supported by the end plate; and
An axial restraining member coupled to the endplate and configured to prevent axial movement of the physiologic sensor mount when the physiologic sensor mount is secured to the tail of the animal.

2. The small animal restraining tube with physiologic sensor mount according to claim 1 further including a tail lashing member secured to the endplate configured to allow the tail to be lashed to the tail lashing member at an axial position closer to the distal end of the tail than the location of the physiologic sensor mount.

3. The small animal restraining tube with physiologic sensor mount according to claim 2 wherein the axial restraining member is a vertical surface extending from the tail lashing member and configured to abut the physiologic sensor mount and wherein the axial restraining member is coupled to the endplate through the tail lashing member.

4. The small animal restraining tube with physiologic sensor mount according to claim 3 wherein the tail lashing member includes a recess configured to selectively receive the physiologic sensor mount therein.

5. The small animal restraining tube with physiologic sensor mount according to claim 4 wherein the physiologic sensor mount is a tail clip for pulse oximetry sensors.

6. The small animal restraining tube with physiologic sensor mount according to claim wherein the tube further includes an access opening at a lower position thereof adjacent the endplate that is configured to allow for outflow of animal waste products of animals confined within the tube.

7. The small animal restraining tube with physiologic sensor mount according to claim 1 further including a cable receiving member coupled to the end plate wherein the cable receiving member is configured to receive a cable extending from the physiologic sensors received within the physiologic sensor mount.

8. The small animal restraining tube with physiologic sensor mount according to claim 1 wherein the nosecone is axially moveable within the tube and selectively secured thereto, wherein the nosecone includes a handle non-rotationally fixed to the nosecone for advancing the nosecone axially along the tube.

10. The small animal restraining tube with physiologic sensor mount according to claim 1 wherein the end plate and the physiologic sensor mount is rotational relative to the tube.

11. The small animal restraining tube with integral physiologic sensor mount according to claim 1 further including an aperture reducing plate selectively coupled to the end plate to reduce the area of the tail receiving opening through the end plate.

12. The small animal restraining tube with physiologic sensor mount according to claim 1 wherein the physiologic sensor mount includes one portion that is integral with the end plate whereby the axial restraining member includes the material forming the integral connection between the sensor mount and the endplate.

13. The small animal restraining tube with physiologic sensor mount according to claim 1 wherein the physiologic sensor mount is configured to receive pulse oximetry sensors.

14. The small animal restraining tube with physiologic sensor mount according to claim 1 further including a temperature indicating mechanism coupled to the tube.

15. A small animal restraining tube assembly with pulse oximetry sensor mount comprising:
A tube configured to receive a small animal therein;
A nosecone within the tube and coupled thereto and configured to abut the animal within the tube to confine the animal on one side of the tube;
An endplate coupled to the tube and configured to confine a body portion of the animal on a side opposite the nosecone, whereby the body of the animal is confined within the tube between the nosecone and the endplate, the endplate including an opening there through configured to receive a tail of the animal when the animal is confined within the tube; and
A physiologic sensor mount configured to be secured to the animal when the animal is confined within the tube, the physiologic sensor mount configured to receive at least one non-invasive pulse oximetry sensor there in, and configured to be supported by the assembly.

16. The small animal restraining tube with pulse oximetry sensor mount according to claim 15 wherein the end plate and the physiologic sensor mount is rotational relative to the tube.

17. The small animal restraining tube with pulse oximetry sensor mount according to claim 15 wherein the physiologic sensor mount includes one portion that is integral with the end plate.

18. A small animal restraining tube with physiologic sensor mount comprising:
A tube configured to receive a small animal therein;
A nosecone within the tube and coupled thereto and configured to abut the animal within the tube to confine the animal on one side of the tube;
An endplate coupled to the tube and configured to confine a body portion of the animal on a side opposite the nosecone, whereby the body of the animal is confined within the tube between the nosecone and the endplate, the endplate including an opening there through configured to receive a tail of the animal when the animal is confined within the tube; and
A physiologic sensor mount configured to be secured to the animal when the animal is confined within the tube; and
an temperature indicating mechanism coupled to one of the tube, the end plate or the nosecone.

19. The small animal restraining tube with physiologic sensor mount according to claim 18 wherein the physiologic sensor mount is configured to receive pulse oximetry sensors.

20. The small animal restraining tube with physiologic sensor mount according to claim 18 wherein the end plate and the physiologic sensor mount is rotational relative to the tube.
